(19) United States
(12) Patent Application Publication
(10) Pub. No.: US 2024/0160749 A1
(43) Pub. Date: May 16, 2024

(54) SECURITY AND RELIABILITY OF CLOUD-BASED SYSTEMS BY REMOVING DEVICE FIRMWARE PERSISTENCE

(71) Applicant: INTERNATIONAL BUSINESS MACHINES CORPORATION, ARMONK, NY (US)

(72) Inventors: SANDHYA KOTESHWARA, WHITE PLAINS, NY (US); YUTAKA SUGAWARA, EASTCHESTER, NY (US); PAUL GREGORY CRUMLEY, YORKTOWN HEIGHTS, NY (US); ROBERT MATTHEW SENGER, TARRYTOWN, NY (US); RUDOLF ADRIAAN HARING, CORTLANDT MANOR, NY (US)

(21) Appl. No.: 17/984,771

(22) Filed: Nov. 10, 2022

(51) Int. Cl. G06F 21/60; G06F 21/57; G06F 21/85

(52) U.S. Cl. CPC G06F 21/602; G06F 21/575; G06F 21/85

(57) ABSTRACT

Improving security and reliability of cloud-based systems by removing persistence of device firmware may include downloading, by a networked device, a temporary firmware image, cryptographically verifying the temporary firmware image, and booting the networked device using the temporary firmware image.

### BACKGROUND

### Field of the Invention

The field of the invention is data processing, or, more specifically, methods, apparatus, and products for improving security and reliability of cloud-based systems by removing persistence of device firmware.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Today's computing systems use non-volatile flash memory to store firmware images required during boot. This firmware often includes, for example, firmware for a Host Processor/Platform Controller Hub (PCH), a Baseboard Management Controller (BMC), a Field Programmable Gate Array (FPGA), or a Network Interface Controller (NIC). Since the flash memories save state even when the computing system is powered off, flash memories allow for booting a system immediately upon power up. While this is often a necessity for standalone servers and laptops, for a server operating in the cloud environment, these solutions may not be required and additionally carry many security and reliability concerns.

For components like a BMC/PCH, the firmware is stored typically in off-chip flash memory modules. Off-chip SPI (Serial Peripheral Interface) flashes are accessed via SPI buses which are susceptible to hardware troj an attacks. The flash memory module may also be susceptible to tampering. In bare-metal servers, it is often important that the flash is completely free of any state before the server is re-provisioned to a new customer to avoid backdoor vulnerabilities that may be left on the flash memory module. Additionally, flash memory modules have a limited number of allowed write/erase cycles. If the flash memory module is repeatedly written during an attack, a denial-of-service (DoS) may result due to wearing out the flash memory module.

Some measures have been proposed to improve the security of systems with firmware. These measures include secure boot procedures, measured boot procedures, monitoring and filtering of the SPI bus, using cryptographic checks before firmware updates are performed, and recovery mechanisms to repair compromised firmware. While these measures improve the security of flash-based systems, they do not solve all concerns associated with programming and managing flash memory. In addition, some of these measures increase reliability concerns. For example, in a system with secure boot enabled even a single bit corruption in the firmware will stop the boot process. Such situations are particularly problematic for cloud servers where rolling out incorrect firmware updates onto devices such as the BMC can render the computing system inaccessible via remote management networks. If this situation occurs across thousands of servers, widespread denial of service may result. Hence, a novel solution to presenting firmware to devices in cloud-based systems is needed.

### SUMMARY

Apparatus and methods for improving security and reliability of cloud-based systems by removing persistence of device firmware according to various embodiments are disclosed in this specification. An embodiment of a method includes downloading, by a networked device, a temporary firmware image, and cryptographically verifying the temporary firmware image. The networked device is booted using the temporary firmware image.

In an embodiment, the temporary firmware image is downloaded from a cloud server controller. In another embodiment, the downloading of the temporary firmware image is implemented via a hardware-implemented network connection. In another embodiment, the hardware-implemented network connection comprises a field programmable gate array (FPGA).

In another embodiment, the downloading of the temporary firmware image is implemented via a boot processor executing a software-assisted network connection, where the software-assisted network connection comprises an early-stage boot loader. In an embodiment, all instructions executed by the boot processor from first instruction up to and including the early-stage bootloader are stored in an immutable, write-protected persistent storage to provide first instruction integrity. Accordingly, in one or more embodiments, the boot processor code is immutable from first instruction up to an including the software-assisted network connection that start downloading the temporary firmware image. In an embodiment, instructions executed by the boot processor after downloading the temporary firmware image are provided from the temporary firmware image.

In another embodiment, downloading the temporary firmware image further comprises storing the temporary firmware image in a temporary memory. In another embodiment, storage of the temporary firmware image is provided using an emulated flash interface. In another embodiment, the emulated flash interface is compatible with a serial peripheral interface (SPI) flash module.

In an embodiment, the networked device comprises a server. In another embodiment, the networked devices is a Baseboard Management Controller (BMC) of a server.

An embodiment includes a computer system. The computer system includes a processor, a computer-readable memory, and a computer-readable storage device, and program instructions stored on the storage device for execution by the processor via the memory.

An embodiment includes a computer usable program product. The computer usable program product includes a computer-readable storage device, and program instructions stored on the storage device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram of an exemplary computing system configured for improving security and reliability of cloud-based systems in accordance with embodiments of the present disclosure.

FIG. 2 is a block diagram of an existing conventional procedure for development and updating of firmware in a networked device.

FIG. 3 is a block diagram of an exemplary system configured for improving security and reliability of cloud-based systems in accordance with embodiments of the present disclosure.

FIG. 4 is a block diagram of another exemplary system configured for improving security and reliability of cloud-based systems in accordance with embodiments of the present disclosure.

FIG. 5 sets forth a flow chart illustrating an exemplary method for improving security and reliability of cloud-based systems according to embodiments of the present disclosure.

### DETAILED DESCRIPTION

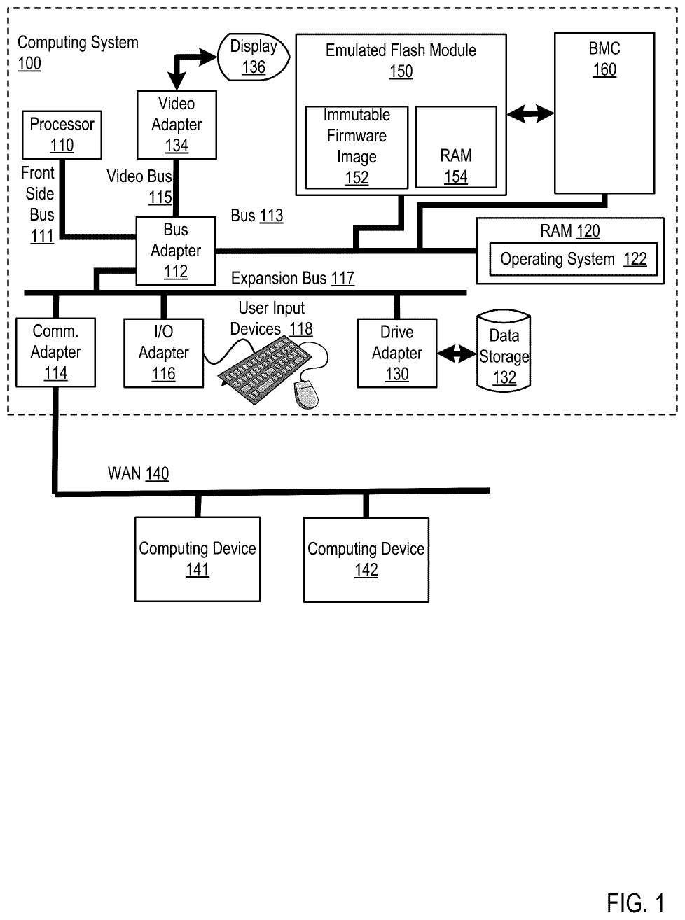

Exemplary methods, apparatus, and products for improving security and reliability of cloud-based systems in accordance with the present invention are described with reference to the accompanying drawings, beginning with FIG. 1. FIG. 1 sets forth a block diagram of automated computing machinery that comprises an exemplary computing system 100 configured for improving security and reliability of cloud-based systems according to embodiments of the present invention. The computing system 100 of FIG. 1 includes at least one computer processor 110 or ‘CPU’ as well as random access memory (‘RAM’) 120 which is connected through a high speed bus 113 and bus adapter 112 to processor 110 and to other components of the computing system 100.

Stored in RAM 120 is an operating system 122. Operating systems useful in computers according to embodiments of the present disclosure include UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (‘I/O’) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers include modems for wired dial-up communications, Ethernet (IEEE 802.3) adapters for wired data communications, and 802.11 adapters for wireless data communications.

The communications adapter 114 of FIG. 1 is communicatively coupled to a wide area network (WAN) 140 that also includes other computing devices, such as computing devices 141 and 142 as shown in FIG. 1. In particular embodiments, the computing system 100 includes a server and computing devices 141 and 142 are client devices of the server.

The exemplary computing system 100 of FIG. 1 includes an emulated flash module 150 and a boot management controller (BMC) 160. In one or more embodiments, the processor 110 functions as a host processor/CPU and is configured to access the emulated flash module 150. The emulated flash module 150 includes an immutable firmware image 152 and RAM 154. The immutable firmware image 152 is stored in a persistent write-protected state. The immutable firmware image 152 includes a minimal set of firmware instructions which, when executed by the BMC 160 cause the computing system 100 to retrieve a firmware image from a trusted external network such as from a cloud server controller of a cloud network. The retrieved firmware image is stored in the RAM 154 and the BMC 160 utilizes this firmware image to complete booting the computing system 100 and operate the computing system 100. In various embodiments, the emulated flash methodology is used to emulate the flashes of both the BMC 160 and the host processor/CPU embodied by processor 110.

As a result, in one or more embodiments, flash-based firmware storage is removed and is effectively replaced with a stateless firmware solution. At every system boot, a fresh copy of the firmware image is brought into the computing system 100 via the external network. Accordingly, the computing system 100 starts from a clean state at every boot, eliminating security and reliability concerns of stateful solutions. To allow existing devices to continue operating in the same manner as in SPI flash or Embedded MultiMediaCard (eMMC) based systems, in certain embodiments the emulated flash module 150 provides an emulated flash interface to allow devices to boot from this emulated flash provided by the emulated flash module 150. In certain embodiments, the emulated flash interface is utilized to incorporate security measures such as monitoring and filtering of downloaded firmware. In some embodiments, networked devices may continue to include measures such as secure boot and measured boot for additional security during boot time. The use of an external network allows for bringing in new images without dependence on the state of devices, which allows for quick corruption detection and recovery.

In one or more embodiments, security and reliability of firmware in cloud servers and other networked devices is improved by downloading the firmware as temporary state from an external network such as a cloud server controller using a control plane before each server boot. In an embodiment, the download procedure is implemented via a hardware-implemented network connection such as by using FPGA logic. In another embodiment, the download procedure is implemented via a boot processor executing a software-assisted network connection such as by using an early-stage boot loader. In such an embodiment, the first instruction or instructions that the boot processor executes are preferably provided from immutable state storage to provide first instruction integrity.

In one or more embodiments, the firmware image is provided by emulated hardware via an interface that is compatible with SPI FLASH.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

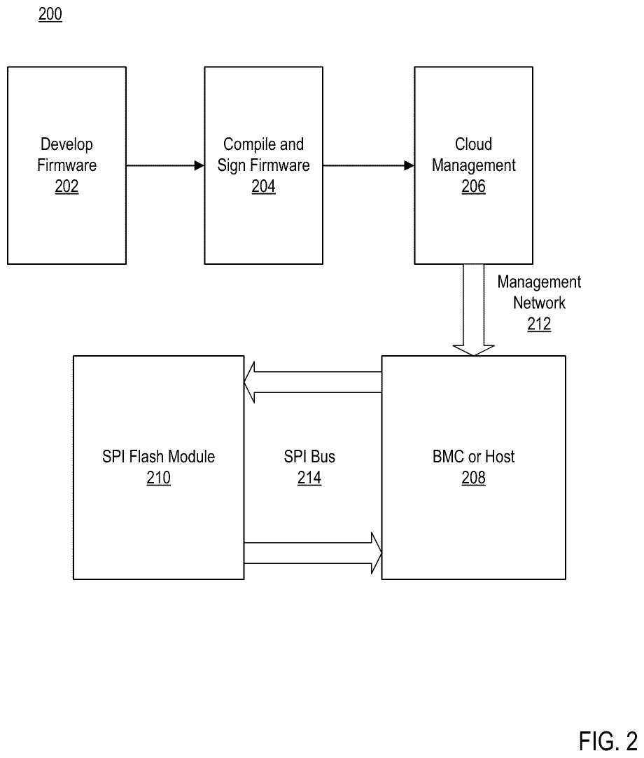

FIG. 2 is a block diagram of an existing conventional procedure 200 for development and updating of firmware in a networked device. In particular, FIG. 2 illustrates different processes involved in the development and updating of firmware onto flash memory of a BMC/PCH of a computing system which includes a firmware development process 202, a compilation and signing of the firmware process 204, and a cloud management process 206. During the firmware development process 202, firmware for the computing system is developed by a developer. After firmware development, the firmware is compiled and signed to create an image during the firmware compilation and signing process 204. The firmware image is then programmed onto memory of a BMC or host 208 by accessing a management network 212 connected to the BMC or host 208. The firmware image is then copied by the BMC or host 208 to an SPI flash module 210 over an SPI bus 214. During a boot process, the BMC or host 208 accesses their respective firmware via the SPI bus 214. Some existing measures to establish trust in this process are often used. During firmware development, open-source code and firmware verification may be used to ensure trust. In addition, the image compilation and signing may be performed by a trusted source. Proper access control and encryption may be provided for sending data across the management network. The BMC or host 208 may verify firmware signatures before update and before boot. Finally, a monitoring or filtering device may be added between the BMC or Host 208 and the SPI flash module 210 to continuously monitor accesses to the SPI flash. However, such existing procedures do not prevent such problems as hardware trojans on the SPI bus, backdoors, tampering, corruption of both primary and backup images as well as other problems.

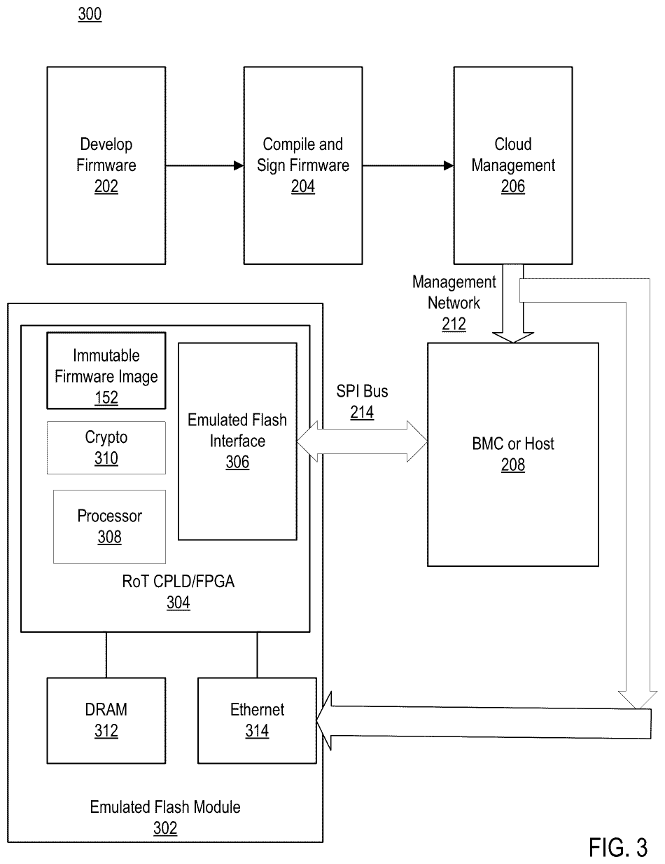

FIG. 3 is a block diagram of an exemplary system 300 configured for improving security and reliability of cloud-based systems in accordance with embodiments of the present disclosure. The system 300 includes the BMC or host 208 in communication with an emulated flash module 302. In one embodiment, the emulated flash module 302 is implemented on a Complex Programmable Logic Device or Field Programmable Gate Array (CPLD/FPGA) which is termed as the Root-of-Trust (RoT) CPLD/FPGA 304. The RoT CPLD/FPGA 304 has sufficient security measures such that it is trusted and functions as the first device to boot in a system. The RoT CPLD/FPGA includes an immutable firmware image 152 and an emulated flash interface 306. The immutable firmware image 152 includes minimal firmware used during initial boot to retrieve a complete firmware image using the management network 212. In a particular embodiment, the emulated flash interface 306 is an SPI flash interface to maintain compatibility with current BMC chips. The embedded flash module 302 further includes DRAM 312 configured for temporarily storing firmware images and an ethernet connection 314. The RoT CPLD/FPGA 304 is connected to the ethernet connection 314 allowing the RoT CPLD/FPGA 304 to be connected and accessible to a management network 212. In a particular embodiment, a CPLD/FPGA configuration required for its own boot is stored in a secure on-chip flash which does not get updated.

Similarly, as described with respect to FIG. 2, firmware is developed (202), compiled and signed (204) and provided to the cloud management process (206). Upon powering up the system 300, the RoT CPLD/FPGA 304 boots first and then holds the BMC or Host 208 in a reset state. Using the management network 212, the cloud management sends BMC or Host firmware images directly to the DRAM 312 attached to the RoT CPLD/FPGA 304. In particular embodiments, the RoT CPLD/FPGA 304 performs cryptographic checks on the firmware before storing it in the DRAM 312. In particular embodiments, the RoT CPLD/FPGA 304 includes a processor 308 (e.g., a hard or soft processor) and cryptographic module 310 for performing the cryptographic checks and for storing cryptographic keys. The BMC or Host 208 is then allowed to boot by accessing the firmware images stored in DRAM 312 via the emulated flash interface 306. During firmware updates, the firmware images stored in DRAM 312 are simply overwritten after performing cryptographic checks. In particular embodiments, access to the emulated flash is controlled by monitoring the emulated SPI flash interface.

In one or more embodiments, the DRAM 312 is chosen to satisfy capacity and speed requirements and accommodates enough capacity to store the necessary firmware images, typically the total of BMC firmware and/or the host processor/PCH firmware. In one or more embodiments, The DRAM 312 is chosen to also meet bandwidth and latency requirements to satisfy the timing of the emulated SPI interface. In one embodiment, two 512 Mbit (64Mx8) Synchronous DRAM (SDRAM) chips are connected to a Lattice MachXO3D CPLD, providing 64 MB firmware capacity for each of the PCH and BMC. In the embodiment, SDRAM operates at 166 MHz, with Column Address Strobe (CAS) latency of 3 cycles. This configuration allows up to 100 MHz of SPI bus clock for fast read commands, and up to 50 MHz for non-fast read commands. In such an embodiment, the SDRAM utilizes 3.3V Low-Voltage Transistor-Transistor Logic (LVTTL) I/O operations which are supported by many commercial CPLDs/FPGAs.

In another embodiment, DDR3-SDRAM is used higher better capacity and access speed. In the embodiment, an 8 Gbit (1G×8) DDR3-SDRAM chip is connected to an Intel MAX 10 CPLD, providing total 1 GB firmware capacity shared by the PCH and BMC. This capacity enables multiple image versions. The DDR3-SDRAM operates at 300 MHz base clock, providing total 600 Mbytes/second per DRAM chip. In such an embodiment, the CPLD/FPGA is configured to support a 1.5V Stub Series Terminated Logic (SSTL) I/O standard to support DDR3-SDRAM.

Accordingly, particular embodiments provide for replacing existing SPI flash memory hardware with DRAM-based temporary firmware storage, and CPLD/FPGA logic to emulate an SPI interface. In particular embodiments, the firmware controller implemented as a CPLD/FPGA downloads firmware from a control plane and keeps the host CPU and BMC in a reset state until the download is completed. In another embodiment, alternately or additionally, downloaded firmware is executed by an early-stage boot controller of the BMC. In other embodiments, embedded or external SRAM or DRAM is used for temporary firmware storage.

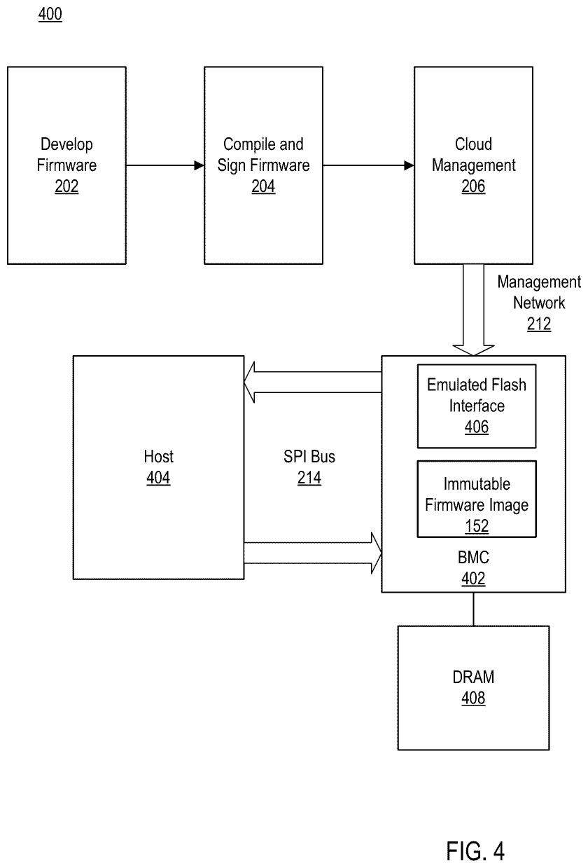

FIG. 4 is a block diagram of another exemplary system 400 configured for improving security and reliability of cloud-based systems in accordance with embodiments of the present disclosure. In the embodiment of FIG. 4, instead of using an additional RoT CPLD/FPGA for emulating flash memory as described with respect to the embodiments of FIG. 3, a BMC 402 is used to emulate the flash memory. Accordingly, the BMC 402 includes an emulated flash interface 406 and an immutable firmware image 152. The BMC 402 is in communication with a host 404 via an SPI bus 214. The BMC 402 is further connected to an associated DRAM 408.

During an example operation, the BMC 402 boots first using a basic image embodied by the immutable firmware image 152 to allow the BMC 402 to be accessible by an external management network 212. In accordance with various embodiments, this basic image is kept immutable and is not updated. Using the management network 212, images required for complete boot of the BMC 402 and the host 404 are downloaded from the cloud management process 206 via the external management network 212 and stored in the DRAM 408 associated with the BMC 402. The BMC 402 and the host 404 are then allowed to boot using the images stored on the DRAM 408. The emulated flash interface 406 for the host 404 is part of the BMC 402 and may also be used for monitoring and access control.

In a particular embodiment, the basic firmware image used to load the final BMC or PCH firmware into the DRAM 408 is implemented in the form of a U-boot module of a OpenBMC software stack. In such an embodiment, necessary data structures (e.g., keys or certificates) and code are added to the U-boot module to establish a secure connection to the cloud management system via an ethernet interface. In a particular embodiment, the rest of the OpenBMC modules beyond the U-boot (e.g., kernel, memory technology device (MTD), or file system images) are loaded from the management network 212, and provided via the emulated flash interface 406.

In a further embodiment, the basic firmware image is stored in BMC on-chip flash to eliminate any physical off-chip persistent state.

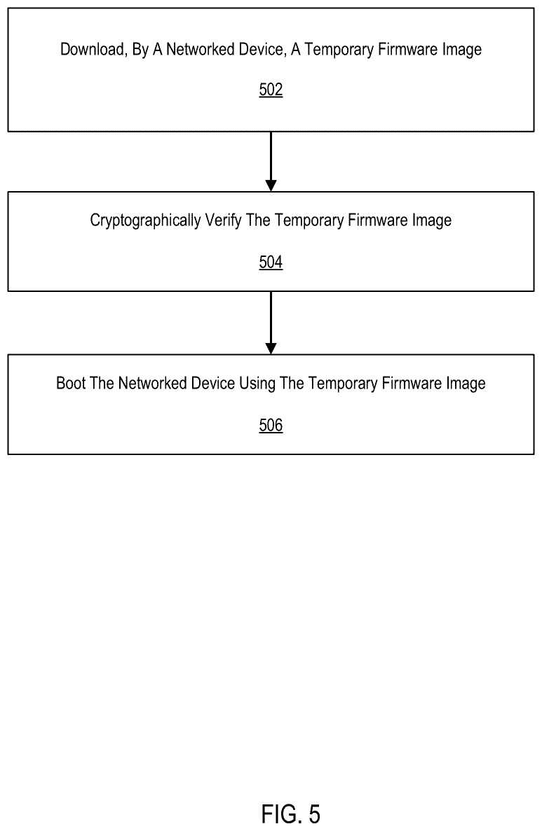

For further explanation, FIG. 5 sets forth a flow chart illustrating an exemplary method for improving security and reliability of cloud-based systems according to embodiments of the present disclosure. The method of FIG. 5 includes downloading 502, by a networked device, a temporary firmware image. In one or more embodiments, the temporary firmware image is a basic firmware image stored in an immutable, write-protected persistent state. The method further includes cryptographically verifying 504 the temporary firmware image. The method further includes booting 506 the networked device using the temporary firmware image. In an embodiment, first instructions are executed by the networked device from the basic firmware image such that initial boot of the networked device is performed using the immutable firmware image. In an embodiment, a firmware image required for a complete boot of the networked device is downloaded from a cloud server controller.

In an alternative embodiment, the downloading of the firmware image is implemented via a hardware-implemented network connection. In an embodiment, the hardware-implemented network connection comprises a field programmable gate array (FPGA).

In an embodiment, the downloading of the firmware image is implemented via a boot processor executing a software-assisted network connection. In an embodiment, the software-assisted network connection comprises an early-stage boot loader. In an embodiment, the early-stage boot loader is stored in an immutable, write-protected persistent memory. In an embodiment, instructions executed by the boot processor after downloading the temporary firmware image are provided from the temporary firmware image.

In an embodiment, downloading the firmware image further comprises storing the firmware image in a temporary memory. In an embodiment, storage of the firmware image is provided using an emulated flash interface. In an embodiment, the emulated flash interface is compatible with a serial peripheral interface (SPI) flash module.

In an embodiment, the networked device comprises a server. In another embodiment, the networked device is a Baseboard Management Controller (BMC) of a server.

In view of the explanations set forth above, readers will recognize that the benefits of improving security and reliability of cloud-based systems by removing persistence of device firmware according to embodiments of the present invention include:
Corrupted firmware images are simply and quickly corrected by rebooting and downloading updated firmware data from a control plane.
Emulated SPI flash hardware can block unauthorized write attempts from a possible hardware troj an on the SPI bus.
Elimination of complex hardware and software mechanisms to protect in-server persistent firmware states.
Provide protection from a DoS attack wearing out flash memory.
Use of emulated SPI flash hardware as a temporary firmware storage medium requires little or no changes to existing BMC or PCH chips.

Exemplary embodiments of the present invention are described largely in the context of a fully functional computer system for improving security and reliability of cloud-based systems by removing persistence of device firmware. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of improving security and reliability of cloud-based systems, the method comprising:
downloading, by a networked device, a temporary firmware image;
cryptographically verifying the temporary firmware image; and
booting the networked device using the temporary firmware image.

2. The method of claim 1, wherein the temporary firmware image is downloaded from a cloud server controller.

3. The method of claim 1, wherein the downloading of the temporary firmware image is implemented via a hardware-implemented network connection.

4. The method of claim 3, wherein the hardware-implemented network connection comprises a field programmable gate array (FPGA).

5. The method of claim 1, wherein the downloading of the temporary firmware image is implemented via a boot processor executing a software-assisted network connection.

6. The method of claim 5, wherein the software-assisted network connection comprises an early-stage boot loader.

7. The method of claim 6, wherein the early-stage boot loader is stored in an immutable, write-protected persistent memory.

8. The method of claim 5, wherein instructions executed by the boot processor after downloading the temporary firmware image are provided from the temporary firmware image.

9. The method of claim 1, wherein downloading the temporary firmware image further comprises storing the temporary firmware image in a temporary memory.

10. The method of claim 9, wherein storage of the temporary firmware image is provided using an emulated flash interface.

11. The method of claim 10, wherein the emulated flash interface is compatible with a serial peripheral interface (SPI) flash module.

12. The method of claim 1, wherein the networked device comprises a server.

13. The method of claim 1, wherein the networked device is a Baseboard Management Controller (BMC) of a server.

14. An apparatus for improving security and reliability of cloud-based systems, the apparatus comprising a computer processor, a computer memory operatively coupled to the computer processor, the computer memory having disposed within it computer program instructions that, when executed by the computer processor, cause the apparatus to carry out the steps of:
downloading, by a networked device, a temporary firmware image;
cryptographically verifying the temporary firmware image; and
booting the networked device using the temporary firmware image.

15. The apparatus of claim 14, wherein the temporary firmware image is downloaded from a cloud server controller.

16. The apparatus of claim 14, wherein the downloading of the temporary firmware image is implemented via a hardware-implemented network connection.

17. A computer program product for improving security and reliability of cloud-based systems, the computer program product disposed upon a computer readable medium, the computer program product comprising computer program instructions that, when executed, cause a computer to carry out the steps of:
downloading, by a networked device, a temporary firmware image;
cryptographically verifying the temporary firmware image; and
booting the networked device using the temporary firmware image.

18. The computer program product of claim 17, wherein the computer readable medium comprises a signal medium.

19. The computer program product of claim 17, wherein the computer readable medium comprises a storage medium.

20. The computer program product of claim 17, wherein the downloading of the temporary firmware image is implemented via a hardware-implemented network connection.
